(19) United States
(12) Patent Application Publication
(10) Pub. No.: US 2019/0072940 A1
(43) Pub. Date: Mar. 7, 2019

(54) AUTOMATION SYSTEM INCLUDING AT LEAST ONE FIELD DEVICE AND AT LEAST ONE CONTROL UNIT

(71) Applicant: Robert Bosch GmbH, Stuttgart (DE)

(72) Inventors: Holger Schnabel, Wuerzburg (DE); Jan Schlechtendahl, Stuttgart (DE); Jochen Scheib, Moensheim (DE); Sebastian Krauskopf, Gemuenden (DE)

(21) Appl. No.: 16/113,749

(22) Filed: Aug. 27, 2018

(30) Foreign Application Priority Data
Sep. 5, 2017 (DE) 10 2017 215 508.6

(51) Int. Cl. G05B 19/418

(52) U.S. Cl. CPC G05B 19/41835; G05B 2219/34256; G05B 2219/31368

(57) ABSTRACT

An automation system includes at least one field device and at least one control unit. The automation system is configured to provide an application interface via which a data transfer of administration data for administration of the at least one field device can be performed from the at least one control unit to the at least one field device.

This application claims priority under 35 U.S.C. § 119 to patent application no. DE 10 2017 215 508.6, filed on Sep. 5, 2017 in Germany, the disclosure of which is incorporated herein by reference in its entirety.

The disclosure relates to an automation system comprising at least one field device and at least one control unit, and to a method for operating such an automation system.

### BACKGROUND

Machines for manufacturing or processing workpieces, for instance machine tools or web processing machines, usually comprise a large number of different machine components or devices (manipulators, motors, regulators, actuators, control units, etc.), which can be networked together by a network such as an Ethernet network. Automation solutions for automated operation of such machines and/or for automated implementation of the manufacturing or processing processes performed by said machines, are usually organized on the basis of what is known as the automation pyramid. According to such an automation solution or automation pyramid, the system is organized into different layers; in other words, different components of the system and the functions performed by these components define different layers of the automation pyramid.

One of these layers is called the field layer, in which in particular the actual manufacturing and/or processing process takes place. The field layer also describes mechanical, electrical, hydraulic, pneumatic or similar machine components, for instance generators, motors, drives. In addition, the field layer comprises field devices which are integrated directly in these components of the production system and are needed for the open-loop and/or closed-loop control of these components of the production system. In this context, the field layer comprises in particular field devices such as sensors, actuators, drives, probes, pushbuttons and switches, for instance.

These field devices of the field layer can be connected to controllers in what is called a control layer, which is at a higher level than the field layer, for instance can be connected to programmable logic controllers. Sensors of the field layer can pass acquired data to these controllers, and/or the controllers can transmit control signals to the actuators of the field layer. Controllers of the control layer can comprise, for example, also a human/machine interface and be used, for instance, for visualizing measurement data.

Controllers of the control layer are themselves in communication with higher-level control units in what is called the operational or management layer, which is at a higher level than the control layer. This management layer in particular defines the topmost layer of the automation system, in which organization, planning and management of the entire system takes place.

Greater interconnection of the individual layers of a machine is increasingly important today, but this is only possible to a limited extent in an automation pyramid.

### SUMMARY

According to the disclosure, an automation system comprising at least one field device and at least one control unit, and a method for operating such an automation system, are proposed. Advantageous embodiments form the subject matter of the following description. Advantages and preferred embodiments of the automation system according to the disclosure and of the method according to the disclosure are apparent analogously from the following description.

The automation system is configured to provide an application interface via which a data transfer of administration data for administration of the at least one field device can be performed from the at least one control unit to the at least one field device.

The at least one field device and the at least one control unit are advantageously components or devices of a machine for manufacturing or processing workpieces, e.g. machine tools or web processing machines. The automation system advantageously facilitates automated operation of this machine and/or automated implementation of the corresponding manufacturing or processing process.

The at least one field device constitutes in particular a device that, according to a conventional automation pyramid, is meant to be assigned to the field layer or the control layer. The at least one control unit is in particular a device that, according to a conventional automation pyramid, is advantageously meant to be assigned to a layer that is at a higher level than the control layer, in particular to the management layer.

For operation of the automation system, in this context a distinction is drawn between the administration data and what is known as field data. The administration data is in particular data for administering, in particular for configuring, setting, checking and/or maintaining, the field devices and/or their functions. In this context, administration data refers in particular to data that instructs the field devices to perform certain functions and/or that can be used to ensure and/or verify safe operation of the field devices. For instance, the administration data may be an executable program code or part of such a program code, the execution of which instructs the field devices to perform certain functions. It is also conceivable that said executable program code is configured, parameterized, checked and/or revised by the administration data. In this context, the administration data is in particular also called management data, and the data transfer of the administration data is advantageously performed as part of what is known as management communication, in the course of which the higher-level control unit accesses the field device in order to administer this device and/or its functions.

In this context, field data refers to data that is generated and exchanged in particular during the execution of functions of the field devices and/or of the machine. The field data advantageously describes a current status of the field device and/or of the machine during the executed function. Field data is advantageously measured and/or calculated by the field devices and/or exchanged between the field devices. In particular, sensor data can be considered to be such field data, i.e. in particular latest values of physical variables measured by sensors. Actual values and/or setpoint values, which are used for the open-loop and/or closed-loop control of the field devices and hence of the machine, can advantageously be understood to be field data in this context. The field data is advantageously also called operating data, and the field data is exchanged in particular as part of what is known as operating-data communication. Thus operating-data communication is aimed particularly at a process performed by the field devices, whereas management communication advantageously relates to a device and machine topology.

In particular, real-time communication is needed for exchanging and/or transmitting field data. In particular a real-time communication channel is used for this purpose, advantageously a real-time fieldbus, motion bus and/or automation bus, for instance Sercos 2, Sercos III, EtherCAT, Profinet IRT, Ethernet/IP, Profibus, etc. In contrast, real-time communication is advantageously not needed for transmitting administration data. The application interface is therefore in particular an interface that is not a real-time interface and can be implemented in the automation system simply and economically.

Thus in the present automation system, management communication is separated from operating-data communication. In the automation system, management or administration data is exchanged in a different way from operating or field data. Thus the disclosure provides an automation solution for machines that differs in particular from conventional automation pyramids and has significant advantages over conventional automation pyramids, as is described below.

According to conventional automation pyramids, the interconnection of field devices in the field layer or control layer to control units in the management layer is usually not easily possible or only possible to a limited extent. In conventional automation pyramids, communication on one layer of the pyramid is called horizontal integration and takes place between the components in this layer. Vertical integration refers to the information flow between components in different layers. The control layer, which according to conventional automation pyramids lies between the field layer and the management layer, is usually responsible for communication between management layer and field layer and hence in particular for the vertical integration. Horizontal communication can also take place within the control layer, for instance between individual controllers or control devices.

In this case, however, the control layer tends to separate the management layer and the field layer from each other rather than connecting these layers together. Devices of the control layer allow devices of the management layer only very limited access to field devices of the field layer. It is hence impossible, or at least barely possible, to access flexibly and spontaneously, according to current need, any field devices of the field layer from devices of the management layer. Controllers of the control layer can usually interact only with those field devices of the field layer and those control units of the management layer in a way intended by its programming, which was defined a priori. Consequently, the control devices can pass only a limited amount of data and information from the field layer to the management layer.

According to conventional automation pyramids or automation solutions, vertical integration is typically confined during operation of the machine to transmitting field data from the field devices “upwards” to control units in the management layer. There is usually no provision, or only very limited provision, for data transfer from the higher-level control units of the management layer to the field devices. In particular, there is usually no provision for data transfer of administration data and hence for administering the machine and/or the field devices during operation of the machine. In conventional automation solutions, administration takes place mostly before the machine is put into operation; subsequent administration or configuration is mostly possible only with considerable expense.

With conventional automation solutions, a posteriori flexible access from devices of the management layer to field devices of the field layer is usually associated with enormous expense, because this usually requires retrospective (manual) modification of devices within the control layer (for instance retrospective modification of PLC programming). Thus in conventional automation pyramids, there is only extremely limited vertical integration, i.e. an extremely limited facility for interaction or communication between field devices of the field layer and devices of the management layer.

Similarly, horizontal integration between field devices of the field layer can be implemented according to conventional automation pyramids only with great expense unless these field devices are connected to one another directly or suitable communication of these field devices is provided a priori via a controller of the control layer.

In contrast, the disclosure facilitates simple and effective interconnection of field devices of the field layer and control layer and control units of the management layer, in particular by separating management communication and operating-data communication. By virtue of the disclosure, it is advantageously unnecessary to use devices of the control layer for the data transfer between field devices of the field layer and control unit of the control layer and hence for the vertical integration, but instead by means of the application interface, direct data transfer between devices of the field layer and/or control layer and devices of the management layer can take place as part of the management communication without intermediary devices.

The management communication via the application interface allows flexible and spontaneous administration of the field devices of the field layer and/or control layer without major expense and advantageously can be carried out at any time. Control units of the management layer can access any field devices in particular flexibly and hence in particular perform administration of the machine and/or of the field devices during operation of the machine.

In addition, the automation system advantageously allows the field devices and/or the control units to communicate between one another via the application interface, thereby economically facilitating both horizontal and vertical integration. In particular, it is hence possible to achieve interconnection of individual devices of a machine without the stringent layer-based structure of conventional automation pyramids. This hence advantageously makes it possible to access flexibly and spontaneously, according to current need, any field devices of the field layer and/or any control units of the control layer from devices of the management layer.

The application interface is advantageously provided as an executable computer program on the at least one field device and/or on a processing unit connected to the at least one field device. The application interface is hence advantageously implemented as a software interface and is effected in particular by a software component or a service program. This software component or the executable computer program can be integrated directly in the field device, for instance PLC, drive, I/O coupler, or can run on separate hardware (gateway) and assume the management of the lower-level field devices. Such a gateway or such a processing unit, which is connected to the at least one field device, advantageously allows the application interface to be introduced retrospectively into a machine and to upgrade an existing machine accordingly. Also if the field devices do not have enough resources to execute the relevant software component, using a processing unit connected to the at least one field device is advantageous for implementing the application interface.

The at least one control unit is preferably embodied as an external processing unit, advantageously as a server, and/or as a remote, distributed processing unit system, in particular what is known as a Cloud. For instance, the at least one control unit can also be used as a conventional PC or a smart device, in particular a portable handheld device, e.g. a touchscreen handheld device, for instance a smartphone or a tablet PC. The at least one control unit is advantageously used as part of the management layer, which in particular characterizes enterprise management of an enterprise, which enterprise management operates the relevant machine and includes in particular both planning the production process specifically, and managing and organizing the resources of the entire enterprise (capital, resources or personnel) in general. The at least one control unit is advantageously used in the course of running and organizing a specific technical production process.

The at least one field device is preferably embodied as a sensor and/or an actuator and/or a drive and/or a probe and/or a pushbutton and/or a switch and/or a controller. A field device embodied as a controller is advantageously arranged at a lower level than the at least one control unit of the management layer and is meant to be assigned in particular to the control layer, and can be embodied as a programmable logic controller (PLC), CNC controller (computerized numerical control), NC controller (numerical control), motion logic controller (MC: motion control) and/or embedded microcontroller system. Such field devices are in particular capable of sending and receiving field data in the form of measurement signals and/or measurement data and/or open-loop/closed-loop control signals, which can be used for open-loop and/or closed-loop control of the machine and/or of the corresponding production process.

The field devices and the control units can be arranged spatially close to one another, and can be arranged in the same building, for instance, or can also be spatially far apart from one another. In the latter case, the field devices can be arranged in a building, for example, in which the machine is located and in which the corresponding production process is carried out. The control units of the management layer can be arranged, for example, in an administration building, which is remote from this building.

The at least one field device and the at least one control unit are advantageously components or devices of a machine, which can be embodied in particular as a machine tool such as, for instance, a welding system, a screw-fastening system, a wire saw or a milling machine, or as a web processing machine such as, for instance, a printing machine, a newspaper printing press, a gravure printing press, a screen-printing machine, an inline flexographic printing press or a packaging machine. The machine can also be embodied as a (belt conveyor) system for manufacturing an automobile or for manufacturing components of an automobile (e.g. internal combustion engines or control modules). In particular, the machine is used to manufacture, process or convey a workpiece or product.

According to a preferred embodiment, the provided application interface checks whether a data transfer of administration data is meant to take place. If this is the case, the data transfer is performed. In this process, the application interface, in particular the corresponding executed computer program, advantageously establishes autonomously without prompting a connection to the at least one control unit, and asks this control unit whether a data transfer is meant to take place. In particular, encrypted Web protocols, for instance https, websockets, are used in this case for the application interface.

Advantageously, a configuration of the at least one field device is performed by means of the data transfer for administration of the at least one field device, for instance a product configuration or configuring data-provision for the at least one field device. Software that is executed to perform functions of the field device can advantageously be configured for this purpose. In particular this makes it possible to configure the data provision retrospectively by managing this software.

Preferably, an executable program code, in particular an application, is loaded from the at least one control unit onto the at least one field device by means of the data transfer for administration of the at least one field device. In particular, a new or revised function of the field devices can be implemented by this executable program code. In particular, a completely new program code and a completely new function of the field devices can be implemented retrospectively during operation of the machine.

Advantageously, an update, in particular a security update, of the at least one field device is performed by means of the data transfer for administration of the at least one field device. An existing program code can thereby advantageously be revised or replaced easily.

Preferably, parameterization of the at least one field device is performed by means of the data transfer for administration of the at least one field device. Thus a plurality of field devices can advantageously be parameterized centrally by the higher-level control unit and not locally on each field device itself.

Preferably, monitoring of the at least one field device is performed by means of the data transfer for administration of the at least one field device, in particular status monitoring, device monitoring and/or machine monitoring. It is hence possible to check whether the field devices and/or the machine are working correctly and whether measured values, which describe a current status of the machine, lie within permitted tolerance bands.

Preferably, maintenance of the at least one field device is performed by means of the data transfer for administration of the at least one field device, in particular preventive maintenance. It is hence possible to perform automatic maintenance of the machine remotely economically, in particular without manual intervention by employees.

Preferably, the at least one field device is put into operation by means of the data transfer for administration of the at least one field device. Hence advantageously, putting into operation can be performed automatically remotely without manual intervention of an employee.

Advantageously, the at least one field device can also be taken out of operation by means of the data transfer, for instance in order then to perform maintenance by means of a further data transfer. The field device can then be put back into operation by means of a further data transfer.

Advantageously, licensing of the at least one field device and/or of a functionality of the at least one field device is performed by means of the data transfer for administering the at least one field device. For instance, after maintenance has been performed successfully, a corresponding license can be extended.

The data transfer of administration data is preferably performed in accordance with IT security mechanisms for protecting confidentiality, integrity and availability. Such IT security mechanisms in particular relate to protecting organizations, for instance enterprises, and their assets, from threats, and to avoiding financial damage. In particular, suitable IT security mechanisms can restrict access to the administration data and permit this access only to authorized users or programs. Thus the IT security mechanisms advantageously ensure the protection objectives of confidentiality, availability and integrity. In this context, confidentiality shall be understood to mean in particular that only authorized users are allowed to read and/or modify (administration) data. This applies in particular both for access to stored data and during the data transfer. Integrity achieves, in particular, that changes to data cannot go unnoticed and that all changes are traceable in particular. Availability prevents, in particular, system failures because access to the (administration) data is guaranteed within an agreed timeframe. Possible examples of such IT security mechanisms are the use of encryption mechanisms, signatures and/or firewalls, the creation of backup copies, etc.

A processing unit according to the disclosure is configured, in particular by software, to perform a method according to the disclosure. In particular, a suitable computer program for providing the application interface can be executed on this processing unit. In this case, the processing unit may be connected to the at least one field device or may itself be embodied as one of the field devices for instance as a PLC, drive, I/O coupler, etc.

Implementing the method in the form of a computer program is also advantageous because this results in particularly low costs especially if an executing control device is still used for other tasks and hence is present anyway. Suitable data storage media for providing the computer program are, in particular, magnetic, optical and electrical storage devices such as, for instance, hard drives, flash memories, EEPROMs, DVDs, etc. Downloading a program via computer networks (Internet, intranet, etc.) is also possible.

The description and the accompanying drawing contain further advantages and embodiments of the disclosure.

It shall be understood that the features mentioned above and still to be explained below can be used not just in the particular combination stated but also in other combinations or in isolation without departing from the scope of the disclosure.

The disclosure is illustrated schematically by exemplary embodiments in the drawing and is described in detail below with reference to the drawing.

### BRIEF DESCRIPTION OF THE DRAWINGS

FIG. 1 shows schematically a conventional automation system of a machine according to the prior art.

FIG. 2 shows schematically a preferred embodiment of an automation system according to the disclosure of a machine, which system is configured to perform a preferred embodiment of a method according to the disclosure.

### DETAILED DESCRIPTION

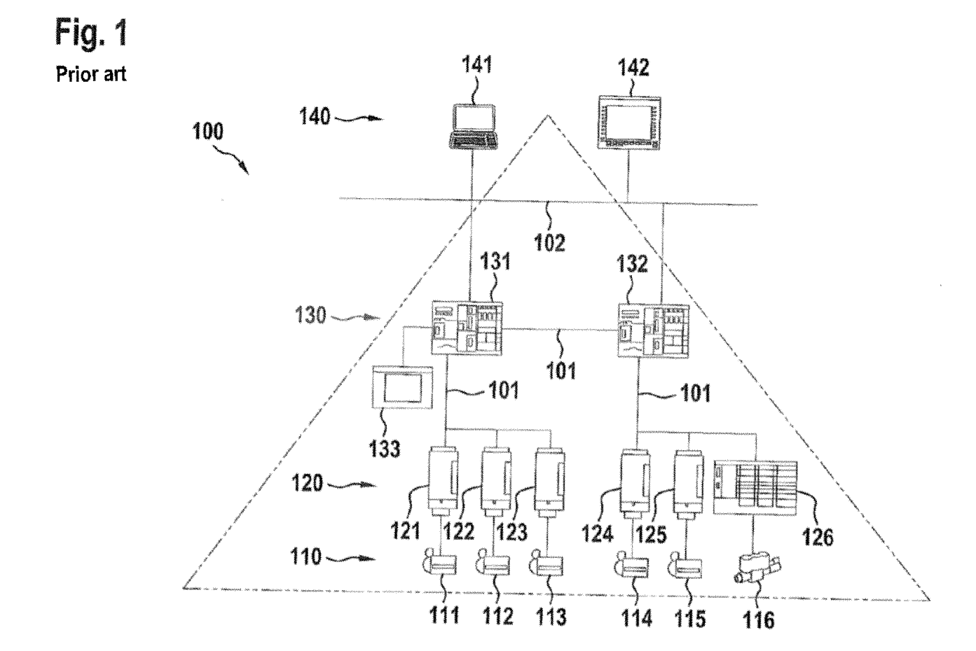

A conventional automation system of a machine according to the prior art is shown schematically in FIG. 1 and denoted by 100.

The machine is embodied as a web processing machine, for example, which can be used to manufacture workpieces as part of a production process. A conventional automation solution 100 based on the automation pyramid, according to which the machine is organized into different layers, is provided for automated operation of this machine and/or automated implementation of the production process. Different machine components define different layers of the automation pyramid.

Servo-engineering field devices 110 are provided in a lowest of these layers, known as the field layer. Actuators in the form of servomotors 111 to 115 and sensors 116 are provided as examples of said field devices 110. The servomotors 111 to 115 can be used, for example, to set conveyor belts moving and to control robot arms, which process and/or carry workpieces conveyed on the conveyor belts.

In addition to the servo-engineering field devices 110, further field devices 120 for input/output or for drive amplification are provided in the field layer. The servomotors 111 to 115 are each connected to a drive amplifier 121 to 125. The sensors 116 are connected to an I/O coupler 126.

Controllers 130, which are intended for controlling the field devices 110, 120 of the field layer, are provided in a control layer, which is at a higher level than the field layer. For this purpose, the controllers 130 of the control layer exchange field data, for instance sensor data, actual and setpoint values, with the field devices 110, 120 of the field layer. This field data or operating data is generated and exchanged during execution of functions of the field devices 110, 120.

In order to ensure precise open-loop and/or closed-loop control of the machine 100, real-time communication in particular is needed for exchanging this field data (known as operating-data communication). Therefore real-time communication channels 101, for instance fieldbuses such as Sercos, Profibus, Profinet, etc., are provided for the operating-data communication.

In the example shown, the field devices 111 to 113 and 121 to 123 are connected to the PLC 131 via a first fieldbus, and the field devices 114 to 116 and 124 to 126 are connected to the PLC 132 via a second fieldbus. In addition, the controllers 131 and 132 are connected together via a further fieldbus.

For example, a further controller 133 acting as a human-machine interface, for instance for visualizing measurement data, can be provided in the control layer.

The topmost layer of the automation pyramid is the management layer, which is at a higher level than the control layer and in which organization, planning and management of the entire machine takes place. The management layer characterizes in particular enterprise management of an enterprise, which enterprise management operates the machine and can include in particular both planning the production process specifically, and managing and organizing the resources of the entire enterprise (capital, resources or personnel) in general. In the present example, a PC 141 and a server 142 are shown as the control units 140 in this management layer, which are connected to the controllers 131, 132 of the control layer via an Ethernet connection 102, for example.

Communication on one layer of the automation pyramid is called horizontal integration and takes place between the components of this layer. Vertical integration refers to communication between components in different layers. In such an automation solution 100 based on a conventional automation pyramid, horizontal and vertical integration are usually possible only to a very limited extent.

In the automation solution 100, the controllers 130 of the control layer are responsible for communication of the field devices 110, 120 of the field layer with the control units 140 of the management layer. In this solution, the controllers 130 of the control layer usually interact with certain field devices in a specific manner only in accordance with their programming, which was defined a priori. Flexible, spontaneous access from control units 140 of the management layer to any field devices 110, 120 of the field layer is usually not possible here.

In addition, horizontal integration of the field devices 110 and/or 120 of the field layer between one another is also barely possible, because only communication of the field devices 120 with the corresponding controller 131 or 132 is provided a priori.

Therefore the disclosure proposes an automation system that facilitates simple and effective interconnection of field devices 110, 120, 130 of the field layer and control layer and control units 140 of the management layer and that facilitates economically both horizontal and vertical integration.

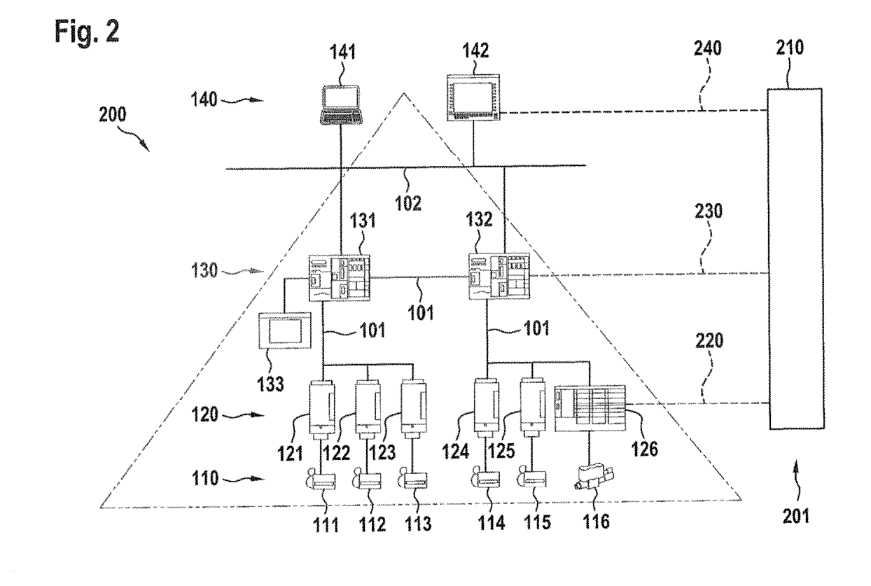

A preferred embodiment of an automation system according to the disclosure of a machine is shown schematically in FIG. 2 and denoted by 200. Identical reference signs in FIGS. 1 and 2 denote identical or equivalent elements.

The automation system 200 is configured to provide an application interface 201 between field devices 110, 120, 130 of the field layer and control layer and control units 140 of the management layer. This application interface 201 is embodied in particular as a software interface and is provided, for example, by an executable computer program, which is executed on a processing unit 210 (gateway). This processing unit 210 is connected to the field devices 110, 120, 130 of the field layer and control layer and to the control units 140 of the management layer via a (not necessarily real-time) communication link 220, 230 and 240 respectively.

A data transfer of administration data for administration of the field devices 110, 120, 130 can be performed from the control units 140 of the management layer via this application interface 201. In this context, such administration data refers in particular to data that instructs the field devices 110, 120, 130 to execute certain functions and/or that can be used to ensure and/or check safe operation of the field devices. The administration data is in particular also called management data. A data transfer of the administration data is advantageously performed as part of what is known as management communication, in the course of which the control units 140 can access the field devices 100, 120, 130 in order to administer these devices and/or their functions.

In particular, management communication is thereby separated from operating-data communication. Operating-data communication can advantageously take place here, similar to the above description with reference to FIG. 1, using the real-time communication channels 101 between the controllers 130 of the control layer and the field devices 110, 120 of the field layer. Management communication is advantageously implemented not via the controllers 130 of the control layer but using the application interface 201.

For this purpose, the automation system 200, in particular the processing unit 210, is configured to perform a preferred embodiment of the method according to the disclosure. In this process, the application interface 201 or the processing unit 210 checks at specified time intervals whether a data transfer from one of the control units 140 to one of the field devices 110, 120, 130 is meant to take place. If this is the case, the data transfer is performed accordingly.

For example, as part of the management communication, the PC 141 can perform maintenance of the servomotors 111 to 115. For this purpose, the PC 141 first takes the servomotors 111 to 115 out of operation by means of a first data transfer of the administration data. Then the checking and/or maintenance is performed by means of a second data transfer of administration data. Then the servomotors 111 to 115 are put back into operation by means of a third data transfer.

What is claimed is:

1. An automation system, comprising:
at least one field device;
at least one control unit; and
an application interface via which a data transfer of administration data for administration of the at least one field device can be performed from the at least one control unit to the at least one field device.

2. The automation system according to claim 1, wherein the application interface includes an executable computer program on the at least one field device and/or on a processing unit connected to the at least one field device.

3. The automation system according to claim 1, wherein the at least one control unit is configured as an external processing unit and/or as a remote distributed processing unit system.

4. The automation system according to claim 1, wherein the at least one field device is configured as a sensor, an actuator, a drive, a probe, a pushbutton, a switch, and/or a controller.

5. A method for operating an automation system including at least one field device, at least one control unit, and an application interface, the method comprising:
transferring administration data for administration of the at least one field device from the at least one control unit to the at least one field device using the application interface.

6. The method according to claim 5, wherein the application interface is provided by a computer program, the method further comprising:
executing the computer program on the at least one field device and/or on a processing unit connected to the at least one field device.

7. The method according to claim 5, further comprising:
checking whether the transferring of administration data is meant to take place with the application interface, and
transferring the administration data if the check indicates that the transferring of administration data is meant to take place.

8. The method according to claim 5, further comprising:
configuring the at least one field device with the transferred administration data.

9. The method according to claim 5, further comprising:
loading an executable program code from the at least one control unit onto the at least one field device based on the transferred administration data.

10. The method according to claim 5, further comprising:
performing an update of the at least one field device based on the transferred administration data.

11. The method according to claim 5, further comprising:
parameterizing the at least one field device based on the transferred administration data.

12. The method according to claim 5, further comprising:
monitoring the at least one field device based on the transferred administration data.

13. The method according to claim 5, further comprising:
performing maintenance of the at least one field device based on the transferred administration data.

14. The method according to claim 5, further comprising:
putting the at least one field device into operation based on the transferred administration data.

15. The method according to claim 5, further comprising:
licensing the at least one field device based on the transferred administration data.

16. The method according to claim 5, further comprising:
transferring the administration data in accordance with IT security mechanisms for protecting confidentiality, integrity and availability.

17. The method according to claim 5, wherein a processing unit is configured to perform the method.

18. The method according to claim 17, wherein a computer program is configured to cause the processing unit to perform the method when the computer program is executed on the processing unit.

19. The method according to claim 18, wherein the computer program is stored on a machine-readable storage medium.
